(19) United States
(12) Patent Application Publication
(10) Pub. No.: US 2025/0153638 A1
(43) Pub. Date: May 15, 2025

(54) BATTERY ELECTRIC VEHICLE

(71) Applicant: TOYOTA JIDOSHA KABUSHIKI KAISHA, Toyota-shi (JP)

(72) Inventors: Takahiro UCHIDA, Kasugai-shi (JP); Seiji ARAKAWA, Nisshin-shi (JP); Kazuhito SAKAI, Mishima-shi (JP); Chie FUKUHARA, Toyota-shi (JP)

(73) Assignee: TOYOTA JIDOSHA KABUSHIKI KAISHA, Toyota-shi (JP)

(21) Appl. No.: 18/940,346

(22) Filed: Nov. 7, 2024

(30) Foreign Application Priority Data
Nov. 15, 2023 (JP) 2023-194649

(51) Int. Cl. B60Q 9/00; B60L 50/51; B60R 11/02; H04R 5/02

(52) U.S. Cl. CPC B60Q 9/00; B60L 50/51; B60R 11/0217; H04R 5/023; B60L 2270/42; H04R 2499/13

(57) ABSTRACT

A battery electric vehicle is equipped with an MT that uses an electric motor as a driving power device and simulates an MT vehicle. Battery electric vehicle includes one or more processors configured to generate a pseudo-engine sound and to provide the pseudo-engine sound through one or more in-vehicle speakers. In MT mode, the one or more processors perform sound field control so that the listenability of the pseudo-engine sound in the first in-vehicle area and the second in-vehicle area different from the first in-vehicle area differs.

### CROSS-REFERENCE TO RELATED APPLICATION

This application claims priority to Japanese Patent Application No. 2023-194649 filed on Nov. 15, 2023, incorporated herein by reference in its entirety.

### BACKGROUND

### 1. Technical Field

The present disclosure relates to a battery electric vehicle that uses an electric motor as a power unit for travel.

### 2. Description of Related Art

Japanese Unexamined Patent Application Publication No. 2022-036005 (JP 2022-036005 A) discloses a technique of generating, in a vehicle cabin, a virtual sound generated when a virtual vehicle that includes a virtual engine as a drive power source travels.

Besides JP 2022-036005 A, Japanese Unexamined Patent Application Publication No. 2011-215437 (JP 2011-215437 A) and Japanese Unexamined Patent Application Publication No. 2005-241271 (JP 2005-241271 A) can be indicated as examples of documents that indicate the state of the art related to the present disclosure.

### SUMMARY

It is known that a pseudo engine sound that simulates an engine sound is output through a speaker when a battery electric vehicle that simulates a manual transmission (MT) vehicle is driven in a manual mode (MT mode). However, it is not always optimal to uniformly output the pseudo engine sound in the vehicle. There is room for further improvement, as there are various needs for the pseudo engine sound in the vehicle.

One aspect of the present disclosure relates to a battery electric vehicle that uses an electric motor as a power unit for travel and that includes a manual transmission (MT) mode for simulating a manual transmission (MT) vehicle.

The battery electric vehicle includes one or more processors configured to generate a pseudo engine sound and output the pseudo engine sound through one or more in-vehicle speakers. The one or more processors perform sound field control such that a listenability of the pseudo engine sound in a first in-vehicle area is different from a listenability of the pseudo engine sound in a second in-vehicle area that is different from the first in-vehicle area in the MT mode.

According to the present disclosure, the sound field control is performed such that the listenability of the pseudo engine sound in the first in-vehicle area is different from the listenability of the pseudo engine sound in the second in-vehicle area that is different from the first in-vehicle area in the MT mode. By making the listenability of the pseudo engine sound different between the first in-vehicle area and the second in-vehicle area in this manner, it is possible to meet various needs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining an outline of a battery electric vehicle according to Embodiment 1;

FIG. 2 is a block diagram illustrating an example of a functional configuration of a processor;

FIG. 3A is a block diagram illustrating a specific example of sound field control;

FIG. 3B is a block diagram illustrating a specific example of the sound field control;

FIG. 3C is a block diagram illustrating a specific example of the sound field control;

FIG. 3D is a block diagram illustrating a specific example of the sound field control;

FIG. 4A is a diagram illustrating an exemplary configuration of a power control system of the battery electric vehicle;

FIG. 4B is a diagram illustrating an exemplary configuration of the power control system of the battery electric vehicle;

FIG. 5 is a block-diagram illustrating an exemplary configuration of a power control system of battery electric vehicle; and

FIG. 6 is a block diagram illustrating a functional example of the processor according to the second embodiment.

### DETAILED DESCRIPTION OF EMBODIMENTS

A battery electric vehicle according to an embodiment of the present disclosure will be described referring to the accompanying drawings. In the drawings, the same reference numerals are assigned to the same elements, and redundant descriptions thereof will be omitted.

### 1. First Embodiment

### 1-1. Overview

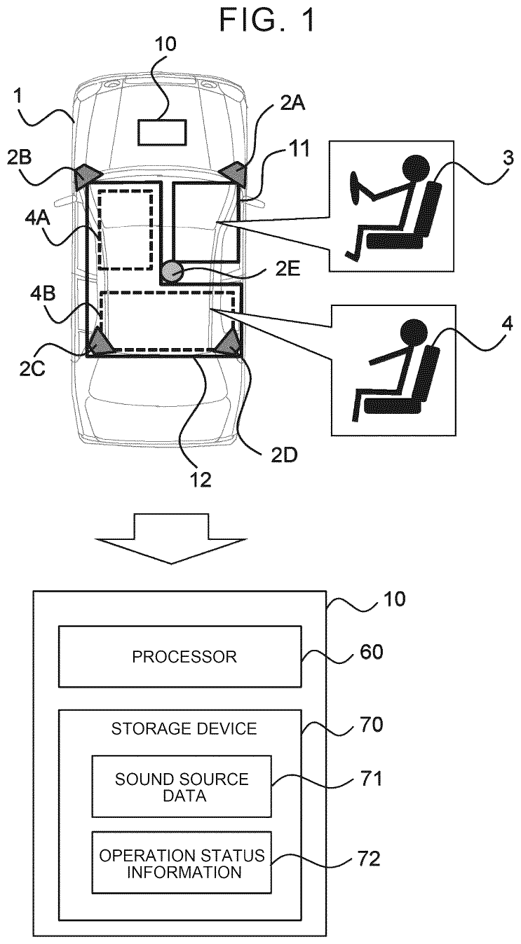

FIG. 1 is a diagram for explaining an outline of a battery electric vehicle 1 (hereinafter, simply referred to as a vehicle 1) according to an embodiment. The vehicle 1 uses an electric motor as a driving power device. In addition, the vehicle 1 is provided with a MT that simulates a manual transmission (MT) vehicle. Details of the configuration of the power control system of the vehicle 1 will be described later.

As illustrated in FIG. 1, the vehicle 1 includes one or a plurality of in-vehicle speakers 2 (hereinafter, simply referred to as speakers 2) and an information processing device 10. The speakers 2 are, for example, well-known directional speakers that output sound in a specific direction. The speakers 2 are provided individually for outputting sounds to the driver's seat 3, the front passenger's seat 4A, and the rear seat 4B, for example. In the embodiment shown in FIG. 1, a speaker 2A is provided as a speaker 2 for outputting sound to a driver's seat 3, a speaker 2B is provided as a speaker 2 for outputting sound to a front passenger's seat 4A, and speakers 2C and 2D are provided as speakers 2 for outputting sound to a rear seat 4B.

The information processing device 10 is connected to the speakers 2, generates sound output from the speakers 2, and outputs the generated sound through the speaker. For example, the information processing device 10 generates a “pseudo engine sound” simulating the engine sound of the engine vehicle, and outputs the pseudo engine sound through the speakers 2.

The information processing device 10 is, for example, an electronic control unit (ECU), a tablet PC, or the like. The information processing device 10 includes one or a plurality of processors 60 (hereinafter, simply referred to as a processor 60) and one or a plurality of storage devices 70 (hereinafter, simply referred to as a storage device 70). The processor 60 executes various processes. The processor 60 is exemplified by a central processing unit (CPU). The storage device 70 stores various kinds of information necessary for processing by the processor 60. Examples of the storage device 70 include volatile memory, non-volatile memory, a hard disk drive (HDD), a solid state drive (SSD), and the like.

The sound generation program (not shown) is a computer program executed by the processor 60. Various functions of the information processing device 10 may be realized by the processor 60 executing the sound generation program. The sound generation program is stored in the storage device 70. Alternatively, the sound generation program may be recorded in a computer-readable storage medium.

The various kinds of information stored in the storage device 70 include sound source data 71 and operation status information 72. The sound source data 71 is used to generate sound output from the speakers 2. The operation status information 72 indicates a driving state of the vehicle 1. Examples of the driving state of the vehicle 1 include a driving operation amount by a driver, a rotation speed of a wheel, a speed, a virtual engine rotation speed, and the like. The operation status information 72 is detected by a sensor mounted on the vehicle 1 or calculated based on a detection result. The virtual engine rotation speed is a rotation speed of the virtual engine when the vehicle 1 is assumed to be driven by the virtual engine. For example, the virtual engine rotational speed is calculated based on the rotational speed of the wheel, the overall reduction ratio, and the slip ratio of the virtual clutch.

Consider a case where the pseudo engine sound is output from the speakers 2 in the vehicle 1. In this case, a plurality of types of basic sound source data for generating the pseudo engine sound are prepared as the sound source data 71. The plurality of types of basic sound source data include, for example, sound source data of sound caused by engine combustion (for low rotation, medium rotation, and high rotation), sound source data of sound caused by a drive system such as a gear (for low rotation, medium rotation, and high rotation), sound source data of noise sound, sound source data of event sound, and the like. Then, the information processing device 10 generates a pseudo engine sound according to the operating state (e.g., virtual engine rotation speed) of the vehicle 1 by combining one or more pieces of basic sound source data. The method of generating the pseudo engine sound is not particularly limited. For example, a pseudo-engine sound may be generated by a well-known pseudo-engine sound simulator employed in a game or the like. In addition, the vehicle type of the engine vehicle, which is a target for simulating the engine sound, may be designated by the driver.

According to the present embodiment, the information processing device 10 controls the sound field of the pseudo engine sound in the vehicle. In particular, the information processing device 10 includes at least a “non-uniform mode” as the sound field control mode. In the non-uniform mode, the information processing device 10 can make listenability of the pseudo-engine sound in the vehicle 1 non-uniform. In other words, in the non-uniform mode, the information processing device 10 can change the listenability of the pseudo engine sound in the vehicle interior of the vehicle 1 for each in-vehicle area.

Here, the first in-vehicle area 11 and the second in-vehicle area 12 will be described. As an example, the first in-vehicle area 11 is an area including the driver's seat 3 and not including the passenger's seat 4 (passenger's seat 4A and rear seat 4B). Here, the second in-vehicle area 12 includes the passenger's seat 4 (front passenger's seat 4A and rear seat 4B) and is an area that does not include the driver's seat 3. As another example, the first in-vehicle area 11 and the second in-vehicle area 12 may be areas that do not include the driver's seat 3. For example, the first in-vehicle area 11 may include one of the front passenger's seat 4A and the rear seat 4B, and the second in-vehicle area 12 may be an area including the other of the front passenger's seat 4A and the rear seat 4B. That is, an arbitrary area can be set in the first in-vehicle area 11 and the second in-vehicle area 12. The areas set in the first in-vehicle area 11 and the second in-vehicle area 12 are selected by, for example, a driver.

In the non-uniform mode, the information processing device 10 performs the sound field control so that the listenability of the pseudo engine sound in the first in-vehicle area 11 and the second in-vehicle area 12 is different. For example, the plurality of speakers 2 includes a first directional speaker that outputs sound to the first in-vehicle area 11 and a second directional speaker that outputs sound to the second in-vehicle area 12. Each of the first directional speaker and the second directional speaker is assigned to speakers 2 corresponding to each of the first in-vehicle area 11 and the second in-vehicle area 12. In the embodiment illustrated in FIG. 1, when the first in-vehicle area 11 is an area including only the driver's seat 3, a speaker 2A is assigned to the first directional speaker. On the other hand, when the second in-vehicle area 12 is an area including only the passenger's seat 4 (front passenger's seat 4A and rear seat 4B), the speakers 2B, 2C and 2D are assigned to the second directional speaker. In this case, the information processing device 10 sets the outputs of the pseudo engine sounds of the first directional speaker and the second directional speaker to different magnitudes. That is, the information processing device 10 makes the output of the pseudo engine sound from one of the first directional speaker and the second directional speaker smaller than the output of the pseudo engine sound from the other. Accordingly, the easiness of hearing the pseudo engine sound in the first in-vehicle area 11 and the second in-vehicle area 12 can be made different.

In the above embodiment, a plurality of speakers 2 (2A, 2B, 2C, 2D) for outputting sounds to the driver's seat 3, the front passenger's seat 4A, and the rear seat 4B are used, but the present disclosure is not limited thereto. For example, as long as the speakers 2 have a function of switching a direction of outputting a sound, it may be provided in the center of the vehicle (e.g., a ceiling portion in the vehicle) as in the speaker 2E shown in FIG. 1. Even in this case, the information processing device 10 controls the output-direction of the pseudo engine sound from the speaker 2E, so that the listenability of the pseudo engine sound in the first in-vehicle area 11 and the second in-vehicle area 12 can be made different from each other.

As described above, according to the present disclosure, in MT mode, the sound field control can be performed such that the listenability of the pseudo-engine sound in the first in-vehicle area 11 and the second in-vehicle area 12 differs. The first in-vehicle area 11 and the second in-vehicle area 12 can meet various needs by making the listenability of the pseudo engine sound different from each other. Specific examples of various needs will be described later.

### 1-2. Functional Configuration Examples

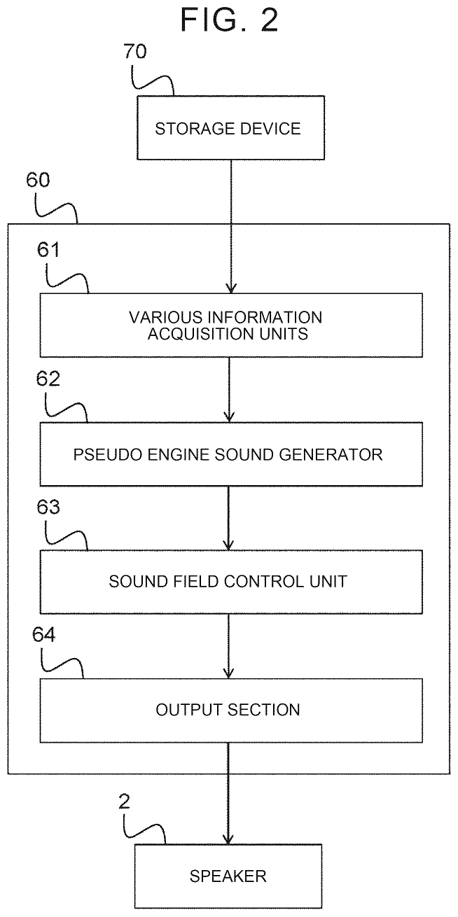

FIG. 2 is a block diagram illustrating a functional configuration example of the processor 60. The processor 60 includes, as functional blocks, a variety of information acquisition unit 61, a pseudo engine sound generation unit 62, a sound field control unit 63, and an output unit 64.

The various information acquisition unit 61 acquires the sound source data 71 and the operation status information 72 from the storage device 70.

The pseudo engine sound generation unit 62 generates a pseudo engine sound based on the sound source data 71 and the operation status information 72. An example of generation of the pseudo engine sound is as described above.

In the non-uniform mode, the sound field control unit 63 performs sound field control so that the listenability of the pseudo engine sound in the first in-vehicle area 11 and the second in-vehicle area 12 is different. For example, the sound field control unit 63 performs the sound field control so that the listenability of the pseudo engine sound in the second in-vehicle area 12 is lower than the listenability of the pseudo engine sound in the first in-vehicle area 11. As another example, the sound field control unit 63 performs sound field control so that the listenability of the pseudo engine sound in the second in-vehicle area 12 is higher than the listenability of the pseudo engine sound in the first in-vehicle area 11.

For example, the sound field control unit 63 sets the outputs of the pseudo engine sounds of the first directional speaker and the second directional speaker to different magnitudes. Examples of the control for changing the output of the directional speaker include sound pressure control of sound, frequency control of sound, volume control, and the like. A specific example of the sound field control will be described later.

In addition to the “non-uniform mode”, a “uniform mode” may be provided as the sound field control mode. In the uniform mode, the sound field control is performed so that the listenability of the pseudo engine sound in the first in-vehicle area 11 and the second in-vehicle area 12 becomes uniform. The switching between the uniform mode and the non-uniform mode may be performed by a driver. For example, a mode changeover switch is provided in the dashboard, and the driver operates the mode changeover switch.

The output unit 64 outputs the pseudo engine sound through the speakers 2 (the first directional speaker and the second directional speaker) under the control of the sound field control unit 63.

### 1-3. Example of Sound Field Control

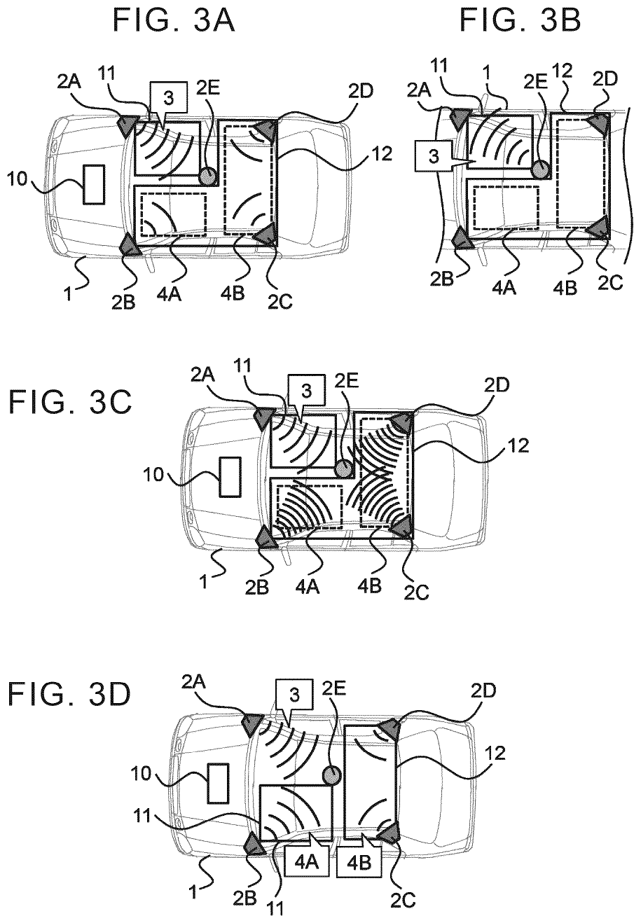

FIGS. 3A to 3D are block diagrams illustrating specific examples of sound field control.

### 1-3-1. First Example

The first example is shown in FIG. 3A. The first in-vehicle area 11 includes the driver's seat 3 and does not include the passenger's seat 4 (front passenger's seat 4A, rear seat 4B). On the other hand, the second in-vehicle area 12 includes the passenger's seat 4 (front passenger's seat 4A, rear seat 4B) and does not include the driver's seat 3. The first directional speaker is a speaker 2A, and the second directional speaker is a speaker 2B, 2C and a 2D. The sound field control unit 63 makes the listenability of the pseudo-engine sound provided in the first in-vehicle area 11 higher than the listenability of the pseudo-engine sound provided in the second in-vehicle area 12. Here, the sound field control unit 63 makes the output of the pseudo engine sound from the second directional speaker (speakers 2B, 2C, 2D) smaller than the output of the pseudo engine sound from the first directional speaker (speaker 2A). For example, the sound field control unit 63 outputs the pseudo engine sound from the first directional speaker and does not output the pseudo engine sound from the second directional speaker.

FIG. 3B is a modification of the first example. In FIG. 3B, a speaker 2E is used. The sound field control unit 63 controls the speaker 2E so as to output the pseudo engine sound toward the first in-vehicle area 11 and not output the pseudo engine sound to the second in-vehicle area 12.

According to the first example, it is possible to make it difficult to hear the pseudo engine sound provided at least in the second in-vehicle area 12 (the passenger's seat 4). As a result, the pseudo engine sound can be output non-uniformly into the vehicle. As a further advantage, for example, for a passenger who does not want to hear a pseudo-engine sound, riding comfort is improved. On the other hand, the driver can enjoy the pseudo-engine sound.

### 1-3-2. Second Example

The second example is shown in FIG. 3C. The first in-vehicle area 11 and the second in-vehicle area 12 are the same as in the first example. The sound field control unit 63 makes the listenability of the pseudo-engine sound provided in the second in-vehicle area 12 higher than the listenability of the pseudo-engine sound provided in the first in-vehicle area 11. Here, the sound field control unit 63 makes the output of the pseudo engine sound from the second directional speaker (speakers 2B, 2C, 2D) larger than the output of the pseudo engine sound from the first directional speaker (speaker 2A).

According to the second example, it is possible to make it easier to hear the pseudo engine sound provided at least in the second in-vehicle area 12 (the passenger's seat 4). As a result, the pseudo engine sound can be output non-uniformly into the vehicle. As a further effect, for example, in a case where the vehicle 1 is a service vehicle (e.g., a taxi) that transports passengers, the passengers in the passenger's seat (passenger's seat 4) can hear a pseudo engine sound, so that the mood can be increased and the comfort of the passengers can be improved.

### 1-3-3-. Third Example

A third example is shown in FIG. 3D. The first in-vehicle area 11 includes a front passenger's seat 4A and does not include a rear seat 4B and a driver's seat 3. The second in-vehicle area 12 includes a rear seat 4B and does not include a front passenger's seat 4A and a driver's seat 3. The first directional speaker is a speaker 2B, and the second directional speaker is speakers 2C and 2D. The sound field control unit 63 makes the listenability of the pseudo-engine sound provided in the first in-vehicle area 11 higher than the listenability of the pseudo-engine sound provided in the second in-vehicle area 12. Here, the sound field control unit 63 makes the output of the pseudo engine sound from the second directional speaker (speakers 2C, 2D) smaller than the output of the pseudo engine sound from the first directional speaker (speaker 2B).

The third example differs from the first example in that both the first in-vehicle area 11 and the second in-vehicle area 12 are the passenger's seat 4 (front passenger's seat 4A, rear seat 4B). This makes it possible to make the pseudo engine sound output into the passenger's seat 4 non-uniform.

According to the third embodiment, the pseudo engine sound provided in the first in-vehicle area 11 (front passenger's seat 4A) can be easily heard, and the pseudo engine sound provided in the second in-vehicle area 12 (rear seat 4B) can be hardly heard. This makes it possible to make the pseudo engine sound output into the passenger's seat 4 non-uniform. As a further advantage, for example, a passenger who wants to hear a pseudo-engine sound may hear a pseudo-engine sound, and a passenger who does not want to hear a pseudo-engine sound may not hear a pseudo-engine sound. In this case, the riding comfort of both the passenger who wants to hear the pseudo engine sound and the passenger who does not want to hear the pseudo engine sound is improved.

In the third embodiment, the first in-vehicle area 11 is the front passenger's seat 4A and the second in-vehicle area 12 is the rear seat 4B, but the first in-vehicle area 11 may be the rear seat 4B and the second in-vehicle area 12 may be the front passenger's seat 4A.

### 1-4. Vehicle Example

### 1-4-1. First Configuration Example

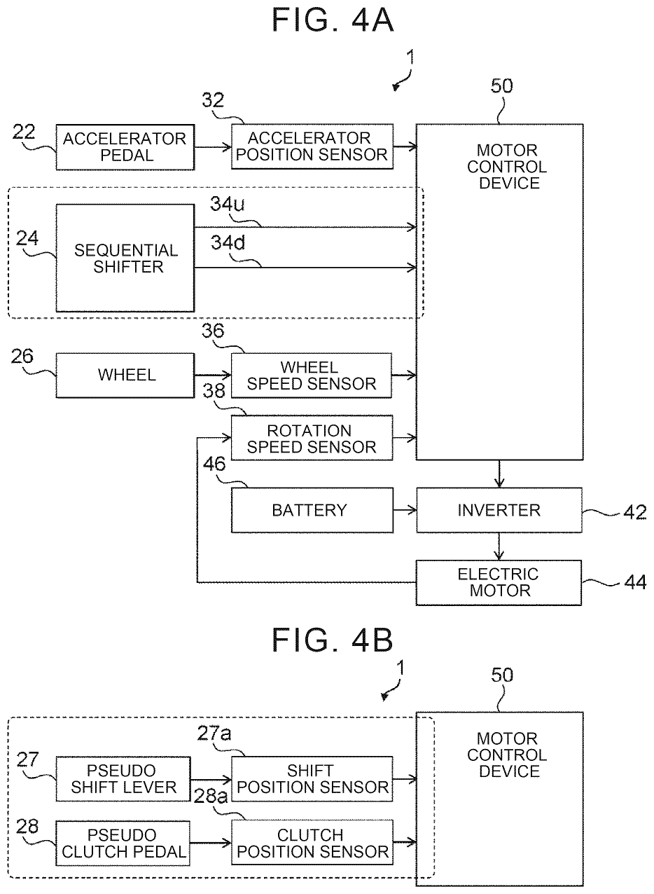

FIG. 4A is a block diagram illustrating a first configuration example of a power control system of the vehicle 1. The vehicle 1 comprises an electric motor 44, a battery 46 and an inverter 42. The electric motor 44 is a driving power device. Vehicle 1 is a battery electric vehicle (BEV) that runs with the electric energy stored in battery 46. The inverter 42 converts DC power input from the battery 46 into drive power of the electric motor 44 at the time of acceleration.

The vehicle 1 includes an accelerator pedal 22 for the driver to input an acceleration request to the vehicle 1. The accelerator pedal 22 is provided with an accelerator position sensor 32 for detecting an accelerator operation amount.

The vehicle 1 includes a sequential shifter 24. The sequential shifter 24 may be a paddle type shifter or a lever type pseudo shifter. The paddle-type shifter and the lever-type pseudo-shifter are different dummies from the original paddle-type shifter and shifter.

The paddle shifter includes an upshift switch and a downshift switch for determining an operating position. The upshift switch is pulled forward to emit an upshift signal 34u, and the downshift switch is pulled forward to emit a downshift signal 34d.

On the other hand, the lever-type pseudo shifter is configured to output an upshift signal 34u by tilting the shift lever forward, and output a downshift signal 34d by tilting the shift lever backward. The lever-type pseudo shifter is connected to the motor control device 50 by an in-vehicle network.

A wheel speed sensor 36 is provided on the wheel 26 of the vehicle 1. The wheel speed sensor 36 is used as a vehicle speed sensor for detecting the vehicle speed of the vehicle 1. Further, the electric motor 44 is provided with a rotation speed sensor 38 for detecting the rotation speed thereof.

The vehicle 1 includes a motor control device 50. The motor control device 50 is a device that controls the electric motor 44 by PWM control of the inverter 42. The motor control device 50 processes various input signals shown in FIG. 3A, and calculates a motor torque command value for controlling PWM of the inverter 42.

The motor control device 50 is a ECU mounted on the vehicle 1. The motor control device 50 may be a part of the information processing device 10 or may be independent of the information processing device 10. The above-described operation status information 72 is generated by the motor control device 50, for example.

The motor control device 50 includes an automatic mode and a manual mode as control modes. The automated mode is a control mode for operating the vehicle 1 as a common battery electric vehicle. The automatic mode is programmed to continuously change the output of the electric motor 44 in response to operation of the accelerator pedal 22. On the other hand, the manual mode is a control mode for driving the vehicle 1 like a MT vehicle. The manual mode is programmed to vary the output characteristics of the electric motor 44 for operation of the accelerator pedal 22 in response to upshift and downshift operations on the sequential shifter 24.

In the automatic mode, the motor control device 50 outputs the motor torque corresponding to the signal of the accelerator position sensor 32 and the signal of the rotation speed sensor 38 by using a map that determines the motor torque from the accelerator operation amount and the rotation speed of the electric motor 44. Therefore, in the automatic mode, even if the driver operates the sequential shifter 24, the operation is not reflected in the motor torque.

The motor control device 50 includes a vehicle model. The vehicle model is a model for calculating a drive wheel torque that is to be obtained by operating the accelerator pedal 22 and the sequential shifter 24 when the vehicle 1 is assumed to be a MT vehicle. In the manual mode, the motor control device 50 calculates the drive wheel torque, and converts the calculated drive wheel torque into the motor torque by using the reduction ratio from the output shaft of the electric motor 44 to the drive wheels.

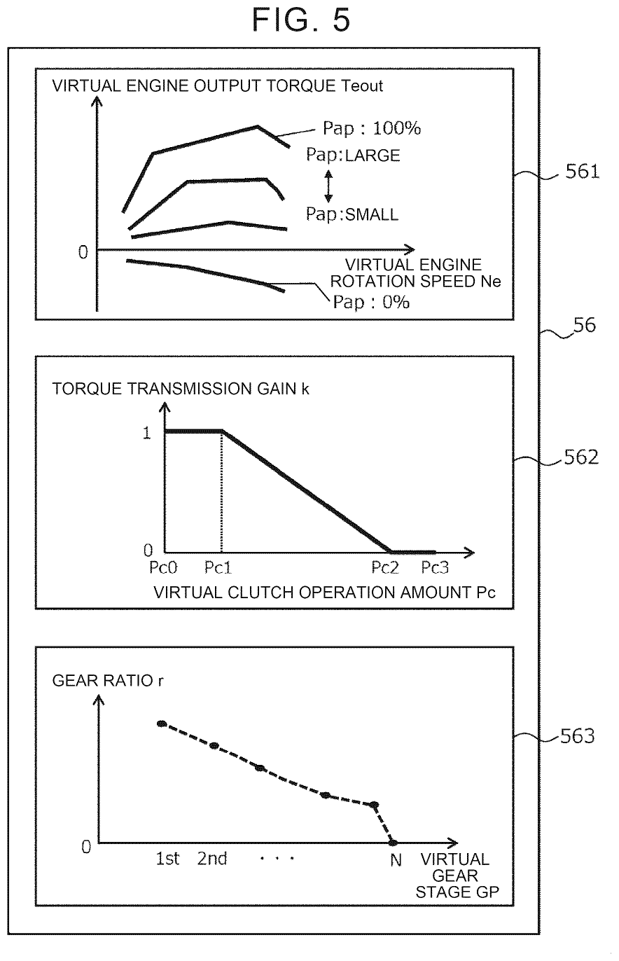

The vehicle model will be described with reference to FIG. 5. As illustrated in FIG. 5, the vehicle model includes an engine model 561, a clutch model 562, and a transmission model 563. The engine, the clutch, and the transmission virtually realized by the vehicle model are referred to as a virtual engine, a virtual clutch, and a virtual transmission, respectively. In the engine model 561, a virtual engine is modeled. In the clutch model 562, a virtual clutch is modeled. In the transmission model 563, a virtual transmission is modeled.

The engine model 561 calculates a virtual engine rotational speed and a virtual engine output torque. The virtual engine rotational speed is calculated from the wheel speed, the overall reduction ratio, and the slip ratio of the virtual clutch. The virtual engine output torque is calculated from the virtual engine rotational speed and the accelerator operation amount. As shown in FIG. 5, a map that defines the relation between the accelerator operation amount Pap, the virtual engine rotation speed Ne, and the virtual engine output torque Teout is used to calculate the virtual engine output torque. In this map, the virtual engine output torque Teout with respect to the virtual engine rotation speed Ne is given for each accelerator operation amount Pap. The torque characteristic shown in FIG. 5 may be set to a characteristic assumed for a gasoline engine, or may be set to a characteristic assumed for a diesel engine. In addition, the torque characteristics may be set to characteristics assumed for a natural intake engine, or may be set to characteristics assumed for a supercharged engine.

The clutch model 562 calculates a torque transmission gain. The torque transmission gain is a gain for calculating the torque transmission degree of the virtual clutch according to the virtual clutch opening degree. The virtual clutch opening is typically 0% and is temporarily opened to 100% in conjunction with the virtual gear stage switching of the virtual transmission. The clutch model 562 has a map as shown in FIG. 5. In this map, the torque transmission gain k is given to the virtual clutch operation amount Pc. In FIG. 5, Pc0 corresponds to a position where the virtual clutch operation amount Pc is 0%, and Pc3 corresponds to a position where the virtual clutch operation amount Pc is 100%. The range from Pc0 to Pc1 and the range from Pc2 to Pc3 are dead zones in which the torque transmission gain k does not change depending on the virtual clutch operation amount Pc. The clutch model 562 calculates the clutch output torque by using the torque transmission gain. The clutch output torque is a torque output from the virtual clutch. Further, the clutch model 562 calculates a slip ratio. The slip rate is used to calculate the virtual engine speed in the engine model 561. The slip ratio can be calculated using a map in which the slip ratio is given to the virtual clutch opening degree in the same manner as the torque transmission gain.

The transmission model 563 calculates a gear ratio (transmission ratio). The gear ratio is a gear ratio determined by the virtual gear stage in the virtual transmission. In response to the up-shift operation of the sequential shifter 24, the virtual gear stage is raised by one stage, and in response to the down-shift operation of the sequential shifter 24, the virtual gear stage is lowered by one stage. The transmission model 563 has a map as shown in FIG. 5. In this map, the gear ratio r is given to the virtual gear stage GP such that the larger the virtual gear stage GP, the smaller the gear ratio r. The transmission model 563 calculates the transmission output torque using the gear ratio and the clutch output torque obtained from the map. The transmission output torque varies discontinuously in response to the change of the gear ratio. This discontinuous change in the transmission output torque causes a shift shock, which produces a vehicle design with a stepped transmission.

The vehicle model calculates the drive wheel torque using a predetermined reduction ratio. The reduction ratio is a fixed value determined by the mechanical structure from the virtual transmission to the drive wheels. A value obtained by multiplying the reduction ratio by the gear ratio is the overall reduction ratio described above. The vehicle model calculates the drive wheel torque from the transmission output torque and the reduction ratio. The motor torque in the manual mode is calculated by multiplying the calculated drive wheel torque by the reduction ratio from the output shaft of the electric motor 44 to the drive wheels.

### 1-4-2. Second Configuration Example

FIG. 4B is a block diagram illustrating a second configuration example of the power control system of the vehicle 1. In the second configuration example, the pseudo shift lever 27 and the pseudo clutch pedal 28 are provided instead of the sequential shifter 24 provided in the first configuration example. The pseudo shift lever 27 and the pseudo clutch pedal 28 are different from the original shift lever and the clutch pedal.

The pseudo shift lever 27 is provided with, for example, positions corresponding to the gear stages of 1 speed, 2 speed, 3 speed, 4 speed, 5 speed, 6 speed, reverse speed, and neutral. The pseudo shift lever 27 is provided with a shift position sensor 27a that detects a gear stage by determining which position the pseudo shift lever 27 is in. The shift position sensor 27a is connected to the motor control device 50 by an in-vehicle network.

The pseudo clutch pedal 28 is provided with a clutch position sensor 28a for detecting a depression amount of the pseudo clutch pedal 28. The clutch position sensor 28a is connected to the motor control device 50 by an in-vehicle network.

Similarly to the first configuration example described above, the motor control device 50 includes an automatic mode and a manual mode as the control modes. The automatic mode is programmed to continuously change the output of the electric motor 44 in response to operation of the accelerator pedal 22. On the other hand, the manual mode is a control mode for driving the vehicle 1 like a MT vehicle. The manual mode is programmed to change the output of the electric motor 44 to the operation of the accelerator pedal 22 in response to the operation of the pseudo clutch pedal 28 and the pseudo shift lever 27.

In the vehicle model provided in the motor control device 50, the virtual clutch operation amount Pc is replaced with the depression amount of the pseudo clutch pedal 28 detected by the clutch position sensor 28a. The virtual gear stage GP is determined by the position of the pseudo shift lever 27 detected by the shift position sensor 27a.

### 2. Second Embodiment

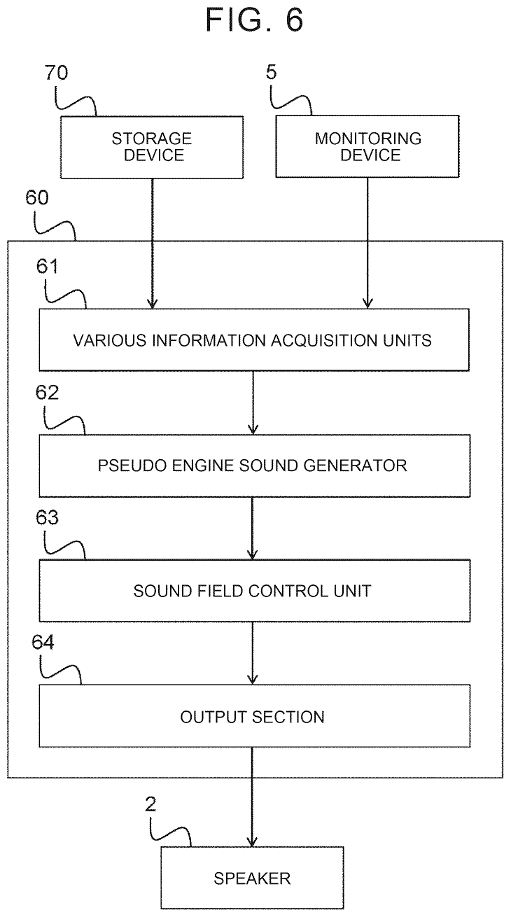

FIG. 6 is a block diagram illustrating a functional example of the processor 60 according to the second embodiment. In the first embodiment, the sound field control of the pseudo engine sound is performed regardless of the state of the passenger. On the other hand, in the second embodiment, the sound field control of the pseudo engine sound is performed according to the state of the passenger. Specifically, the vehicle 1 further includes a monitoring device 5. The monitoring device 5 estimates a passenger state indicating the state of the passenger in the passenger's seat 4. The monitoring device 5 includes a sensor and a control device that estimates a passenger state based on information detected by the sensor. The sensor is, for example, an in-vehicle camera that photographs the inside of the vehicle.

The passenger state is expressed by, for example, at least one of a fatigue level, a stress level, and a sleepiness level. Each of the degree of fatigue, the degree of stress, and the degree of drowsiness is estimated in the monitoring device 5 on the basis of an analysis result (e.g., facial expression, opening and closing of eyes, and frequency of yawning) of a facial image captured by an in-vehicle camera.

As illustrated in FIG. 6, the processor 60 includes, as functional blocks, a variety of information acquisition unit 61, a pseudo engine sound generation unit 62, a sound field control unit 63, and an output unit 64, as in the first embodiment. Here, only the functions (the various information acquisition unit 61 and the sound field control unit 63) different from the first embodiment will be described.

The various information acquisition unit 61 further acquires information on the passenger status from the monitoring device 5.

The sound field control unit 63 estimates whether the passenger state is unfavorable or favorable based on the information on the passenger state. For example, in a case where at least one of the fatigue level, the stress level, and the drowsiness level, which are the passenger state, is in a state higher than the threshold value, the sound field control unit 63 may estimate that the passenger state is malfunctioning. On the other hand, when all of the fatigue level, the stress level, and the drowsiness level are in a state equal to or less than the threshold value, the sound field control unit 63 may estimate that the passenger state is favorable.

Here, the first in-vehicle area 11 is an area including the driver's seat 3 and not including the passenger's seat 4, and the second in-vehicle area 12 is an area including the passenger's seat 4 and not including the driver's seat 3. In this case, the sound field control unit 63 makes the easier hearing of the pseudo engine sound in the second in-vehicle area 12 in the case where the passenger state is favorable, higher than the easier hearing of the pseudo engine sound in the second in-vehicle area 12 in the case where the passenger state is malfunctioning. Incidentally, the second in-vehicle area 12 is a passenger's seat 4 including the front passenger's seat 4A and the rear seat 4B, but it may be limited to the seats for the passengers riding the same passenger that the passenger condition is sluggish. That is, the sound field control unit 63 may set an area corresponding to the first in-vehicle area 11 and the second in-vehicle area 12 based on the passenger state.

According to the second embodiment, the same effects as those of the first embodiment can be obtained. Further, since the driver does not need to make a judgment when performing the sound field control, the driver can enjoy driving in MT mode while listening to the pseudo-engine sound without worrying about the passenger.

### 3. Other Embodiment

If there is a passenger who is likely to sleep in the passenger's seat 4 (e.g., a passenger whose drowsiness level is higher than the threshold value), the processor 60 may make it difficult to hear the pseudo engine sound in the passenger's seat 4 and output a sound that is likely to sleep in the passenger's seat 4 through the speakers 2 corresponding to the passenger's seat 4. Examples of the sleep-prone sound include a sound in a frequency band that a person feels comfortable. As a result, the same effect as in the first or second embodiment is obtained, and further, the riding comfort of the passenger is improved.

What is claimed is:

1. A battery electric vehicle that uses an electric motor as a power unit for travel and that includes a manual transmission (MT) mode for simulating a manual transmission vehicle, the battery electric vehicle comprising one or more processors configured to generate a pseudo engine sound and output the pseudo engine sound through one or more in-vehicle speakers, wherein the one or more processors are configured to perform sound field control such that a listenability of the pseudo engine sound in a first in-vehicle area is different from a listenability of the pseudo engine sound in a second in-vehicle area that is different from the first in-vehicle area in the MT mode.

2. The battery electric vehicle according to claim 1, wherein:
the one or more in-vehicle speakers include a first directional speaker that outputs a sound to the first in-vehicle area, and a second directional speaker that outputs a sound to the second in-vehicle area; and
the sound field control includes making an output of the pseudo engine sound from one of the first directional speaker and the second directional speaker smaller than an output of the pseudo engine sound from the other.

3. The battery electric vehicle according to claim 1, wherein:
the first in-vehicle area includes a driver's seat and does not include a passenger's seat;
the second in-vehicle area includes the passenger's seat and does not include the driver's seat; and
the one or more processors are configured to make the listenability of the pseudo engine sound in the second in-vehicle area lower than the listenability of the pseudo engine sound in the first in-vehicle area in the sound field control.

4. The battery electric vehicle according to claim 1, wherein:
the first in-vehicle area includes a driver's seat and does not include a passenger's seat;
the second in-vehicle area includes the passenger's seat and does not include the driver's seat;
the battery electric vehicle further includes a monitoring device that estimates a passenger state that indicates a state of a passenger in the passenger's seat; and
the one or more processors are configured to make the listenability of the pseudo engine sound in the second in-vehicle area at a time when the passenger state is good higher than the listenability of the pseudo engine sound in the second in-vehicle area at a time when the passenger state is not good in the sound field control.

5. The battery electric vehicle according to claim 1, wherein:
the first in-vehicle area includes a driver's seat and does not include a passenger's seat;
the second in-vehicle area includes the passenger's seat and does not include the driver's seat; and
the one or more processors are configured to make the listenability of the pseudo engine sound in the second in-vehicle area higher than the listenability of the pseudo engine sound in the first in-vehicle area in the sound field control.
